(19) United States
(12) Patent Application Publication
(10) Pub. No.: US 2016/0261028 A1
(43) Pub. Date: Sep. 8, 2016

(54) ANTENNA PATTERN FRAME, ELECTRONIC DEVICE INCLUDING THE SAME, AND METHOD OF MANUFACTURING THE SAME

(71) Applicant: SAMSUNG ELECTRO-MECHANICS CO., LTD., Suwon-si (KR)

(72) Inventors: Su Hyun KIM, Suwon-si (KR); Ha Ryong HONG, Suwon-si (KR); Sung Jun PARK, Suwon-si (KR); Yun Woo LEE, Suwon-si (KR)

(73) Assignee: SAMSUNG ELECTRO-MECHANICS CO., LTD., Suwon-si (KR)

(21) Appl. No.: 14/982,384

(22) Filed: Dec. 29, 2015

(30) Foreign Application Priority Data
Mar. 4, 2015 (KR) 10-2015-0030525

(51) Int. Cl. H01Q 1/24

(52) U.S. Cl. CPC H01Q 1/243

(57) ABSTRACT

An antenna pattern frame and insert injection-molding method of manufacturing including a radiator having an antenna pattern part configured to transmit or receive a signal and a support part extending from one side of the antenna pattern part; and a radiator frame, wherein the antenna pattern part is exposed on one surface of the radiator frame and an end portion of the support part is exposed on an opposite surface of the radiator frame, wherein a bridge groove is disposed in the opposite surface of the radiator frame extending from the exposed end portion of the support part to an edge of the radiator frame.

### CROSS-REFERENCE TO RELATED APPLICATION

This application claims the benefit under 35 USC 119(a) of Korean Patent Application No. 10-2015-0030525 filed on Mar. 4, 2015, in the Korean Intellectual Property Office, the entire disclosure of which is incorporated herein by reference for all purposes.

### BACKGROUND

1. Field

The following description relates to an antenna pattern frame, an electronic device including the same, and a method of manufacturing the same.

2. Description of Related Art

Mobile communications terminals such as mobile phones, personal digital assistances (PDAs), GPS navigation devices, notebooks, and the like, which support wireless communications, have been developed to allow for communications to be undertaken using schemes such as code division multiple access (CDMA), wireless local area network (LAN), digital multimedia broadcasting (DMB), and other wireless signal protocols. One of the most important components enabling these schemes is an antenna. Therefore, research into integrating an antenna with a mobile communications terminal in order to miniaturize the mobile communications terminal and reinforce durability of the antenna has been actively conducted.

In an injection-molding method of integrating the antenna with the mobile communications terminal, a radiator on which an antenna pattern is formed is fixed into a mold and a resin material is injected into the mold. However, in the case of the injection-molding method, the radiator is fixed by forming a guide pin hole in the radiator and inserting a guide pin provided in a mold into the guide pin hole, but the guide pin hole is externally exposed after manufacturing of a product, and thus the exterior appearance is degraded.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna pattern frame has an improved exterior, and an electronic device including the same. The antenna pattern frame includes a radiator having an antenna pattern part configured to transmit or receive a signal and a support part extending from one side of the antenna pattern part; and a radiator frame, wherein the antenna pattern part is exposed on one surface of the radiator frame and an end portion of the support part is exposed on an opposite surface of the radiator frame, wherein a bridge groove is disposed in the opposite surface of the radiator frame extending from the exposed end portion of the support part to an edge of the radiator frame.

In another genera aspect, a method of manufacturing an antenna pattern frame includes combining an upper mold and a lower mold to form an internal space; disposing a radiator and a bridge in the internal space, wherein the bridge comprises a fixing hole; inserting a fixing pin through the upper and lower molds into the fixing hole; injecting a resin into the internal space; and removing the bridge after the injection-molding is completed. A support part is connected to a bridge during the injection-molding. Thus, the radiator is fixed with in the internal space by the fixing pin inserted into the fixing hole provided in the bridge

Therefore, after the injection-molding of the antenna pattern frame is completed, traces left by the fixing hole do not remain on the exterior of the antenna pattern frame, resulting in greater manufacturing efficiency.

Other features and aspects will be apparent from the following detailed description, the drawings, and the claims.

### BRIEF DESCRIPTION OF DRAWINGS

FIG. 1 is a schematic exploded perspective view illustrating an example of an antenna pattern frame coupled to a case of a mobile communications terminal, which is an electronic device;

FIG. 2 is a schematic exploded perspective view illustrating an example of the antenna pattern frame coupled to the case of the mobile communications terminal of FIG. 1, when viewed at a different angle;

FIG. 3 is a schematic perspective view of an example of the antenna pattern frame of FIGS. 1 and 2;

FIG. 4 is a schematic perspective view illustrating the radiator provided in the antenna pattern frame of FIGS. 1-3;

FIG. 5 is a cross-sectional view taken along line A-A′ of FIG. 3;

FIG. 6 is a cross-sectional view taken along line B-B′ of FIG. 3;

FIG. 7 is a schematic bottom view of the antenna pattern frame of FIG. 3;

FIG. 8 is a partial perspective view and a schematic cross-sectional view of another example of an antenna pattern frame;

FIG. 9 is a schematic cross-sectional view of the antenna pattern frame of FIG. 8;

FIG. 10 is a schematic cross-sectional view illustrating an example of disposing a radiator in a mold and filling the mold with a resin material, in a method of manufacturing an antenna pattern frame;

FIG. 11 is a schematic cross-sectional view illustrating another example of disposing a radiator disposed in a mold and filling the mold with a resin material, in a method of manufacturing an antenna pattern frame; and

FIG. 12 is a schematic flowchart illustrating a method of manufacturing an antenna pattern frame.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second component disposed above a first component based on the orientation of the device illustrated in the drawings also encompasses the device when the device is flipped upside down in use or operation.

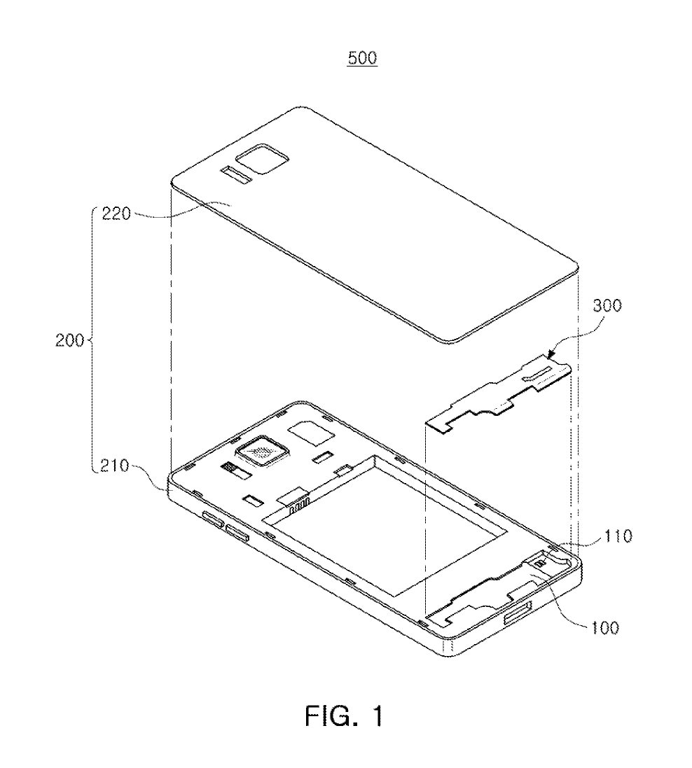

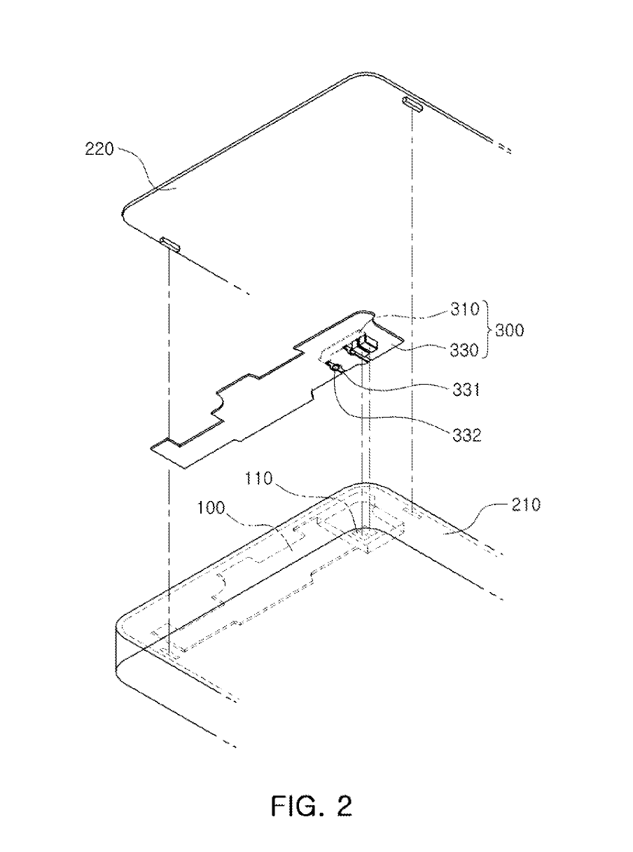

Referring to FIGS. 1 and 2, the electronic device 500 includes a circuit board 100, a housing 200, and an antenna pattern frame 300. Here, the electronic device 500 may be, for example, a mobile communications terminal.

For the circuit board 100, various kinds of boards used in the art (such as a ceramic board, a printed circuit board (PCB), or other boards) may be used. In addition, at least one electronic component may be mounted on the circuit board 100, and mounting electrodes for mounting the electronic component or a wiring pattern (not illustrated) electrically connecting the mounting electrodes to each other may be provided.

The circuit board 100 is electrically connected to an antenna pattern frame 300, described below, to receive signals of a radiator 310 provided in the antenna pattern frame 300 or transmit signals to the radiator 310. Further, a terminal part 110 for connection with respect to the radiator 310 may be provided in the circuit board 100.

The radiator 310 is electrically connected to the terminal part 110 of the circuit board 100 to transmit signals received from an external source or device to the circuit board 100 or transmit signals received from the circuit board 100 externally, thereby serving as an antenna.

The housing 200, includes a front case 210 and a rear cover 220 forming the exterior of the electronic device 500. Various electronic elements for driving or operating the electronic device 500 and the circuit board 100 may be coupled to the front case 210. In addition, the antenna pattern frame 300 is coupled to one side of the front case 210, and the rear cover 220 is provided on the antenna pattern frame 300.

For example, the front case 210 and the rear cover 220 are coupled to each other to form an internal space, and electronic elements required for operating the electronic device 500, the circuit board 100, and the antenna pattern frame 300 may be mounted in the internal space. The rear cover 220 is provided on the antenna pattern frame 300 to prevent the antenna pattern frame 300 from being externally exposed. In this case, the front case 210 and the rear cover 220 may be detachably coupled to each other. For example, the rear cover 220 may be coupled to the front case 210 by a hook.

The front case 210 and the rear cover 220 may be formed of a plastic material. For example, the front case 210 and the rear cover 220 may be formed by injection-molding a resin. However, the material of the front case 210 and the rear cover 220 is not limited thereto, and various changes may be made as long as the front case 210 and the rear cover 220 accommodates the electronic elements, the circuit board 100, and the antenna pattern frame 330 therein.

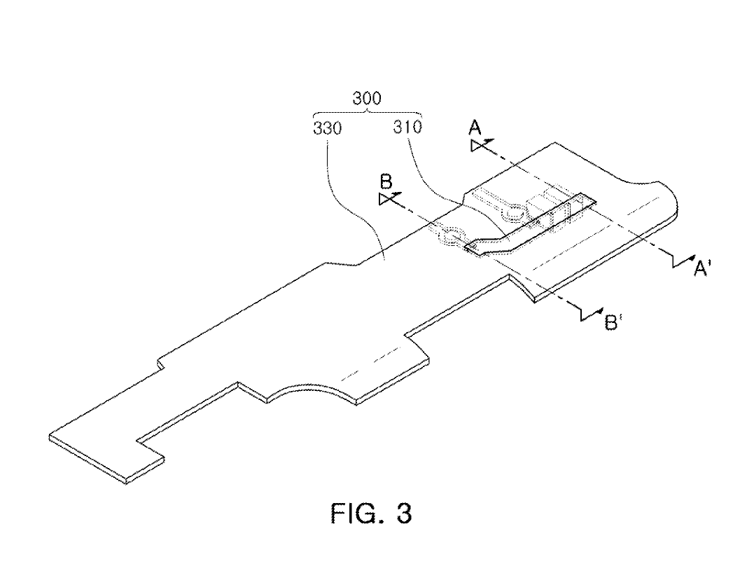

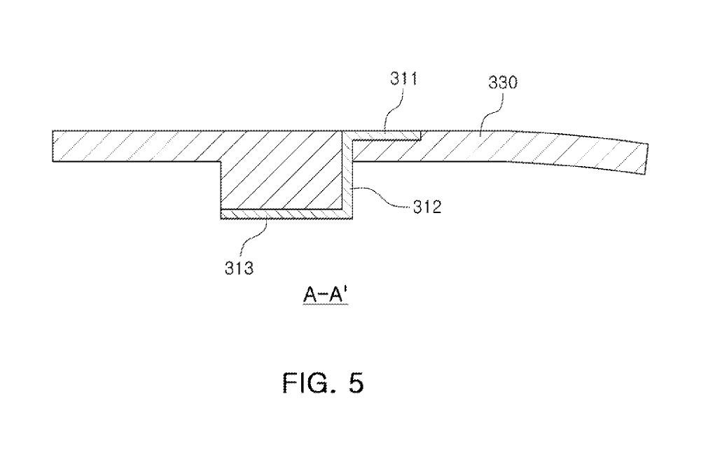

Referring to FIGS. 3 through 7, the antenna pattern frame 300, includes the radiator 310 and a radiator frame 330. The radiator 310 may include an antenna pattern part 311, a connecting part 312, a terminal connection part 313, and a support part 314. The radiator 310 may be manufactured using a conductor such as aluminum or copper, and receives external signals to transmit the signals to a signal processing device (not illustrated) provided in the electronic device 500 or transmit signals of the electronic device 500 to an external receiver (not illustrated). In addition, the radiator 310 has an angled portion in order to receive external signals in various bands.

The radiator 310 includes the antenna pattern part 311 transmitting or receiving signals and the terminal connection part 313 electrically connecting the antenna pattern part 311 to the circuit board 100 in order to transmit the received signal to the electronic device 500 or externally transmit the signals of the electronic device 500. Here, the radiator 310 has a three-dimensional structure in which a connecting part 312 extends perpendicularly from the antenna pattern part 311. The terminal connection part 313 extends perpendicularly from the connecting part 312. In this case, the connecting part 312 connects the antenna pattern part 311 and the terminal connection part 313 to each other so that the antenna pattern part 311 is formed on one surface of a radiator frame 330 to be described below, and the terminal connection part 313 is formed on the opposite surface of the radiator frame 330. Here, the one surface of the radiator frame 330 is a surface of the radiator frame 330 facing the rear cover 220 in FIG. 2, and the opposite surface of the radiator frame 330 is a surface thereof facing the circuit board 100.

The support part 314 extends from one side of the antenna pattern part 311, and an end portion thereof may be exposed to the opposite surface of the radiator frame 330 after an injection-molding process.

As an example, the support part 314 extends from one side of the antenna pattern part 311 through the radiator frame 330, and the end portion is exposed on the opposite surface of the radiator frame 330. In this case, the support part 314 corresponds to a portion connected to a bridge 11, and is separated from the bridge 11 by a separate cutting method after the injection-molding is completed. A plurality of support parts 314 as described above disposed to be spaced apart from each other along the antenna pattern part 311.

The radiator frame 330, an injection-molded structure, forms the exterior of the antenna pattern frame 300, and a portion of the radiator 310 may be embedded in the radiator frame 330. As an example, the radiator frame 330 is molded by insert injection-molding of the radiator 310. The antenna pattern part 311 of the radiator 310 is exposed to one surface of the radiator frame 330, and the connection terminal 313 of the radiator 310 and the end portion of the support part 314 are exposed to the opposite surface of the radiator frame 330. In other words, one surface of the radiator frame 330, which is the injection-molded structure, is provided with the antenna pattern part 311, and the opposite surface thereof is provided with the terminal connection part 313 and the end portion of the support part 314.

The terminal connection part 313 of the radiator 310 has elasticity. For example, when the injection-molding of the radiator 310 is completed, the terminal connection part 313 may be rotated and bent to be spaced apart from the radiator frame 330. In this case, since the radiator 310 is formed of an elastic material, naturally, the terminal connection part 313 is elastic. As a result, the terminal connection part 313 elastically contacts the terminal part 110 of the circuit board 100.

In addition, after the radiator frame 330 is injection-molded, a separate protective film (not illustrated) may be applied onto the antenna pattern part 311. Even in a state in which the rear cover 220 is covered, the antenna pattern frame 300 is not externally exposed. However, in a case in which the rear cover 220 is opened, for example for changing of a battery, the antenna pattern frame 300 is externally exposed. The protective film protects the antenna pattern part.

Here, the protective film may be instantly formed by a liquid having a color equal to or similar to that of the radiator frame 330 through a spraying, coating or painting method or formed by attaching a manufactured component such as a separate film or coating. Since a separate hole for fixedly installing the radiator 310 onto the antenna pattern frame is not required in the antenna pattern part 311, a separate hole line is not externally exposed, and the exterior appearance is improved.

A bridge groove 331 is provided in the opposite surface of the radiator frame 330 from the exposed end portion of the support part 314 to an edge of the radiator frame 330. The bridge groove 331 extends from the exposed end portion of the support part 314 to a side surface 330a of the radiator frame 330 and depressed inwardly of the radiator frame 330 at a predetermined depth L1. In this case, the depth of the bridge groove 331 may be equal to a thickness L2 of the support part 314. Further, the bridge groove 331 has a shape corresponding or conforming to the bridge 11. That is, the bridge groove 331 may be formed by removing the bridge 11 from the support part 314 after the radiator frame 330 is injection-molded. Therefore, the bridge groove 331 corresponds to the support part 314, and in a case in which the plurality of support parts 314 are provided, the plurality of bridge grooves 331 are also be provided.

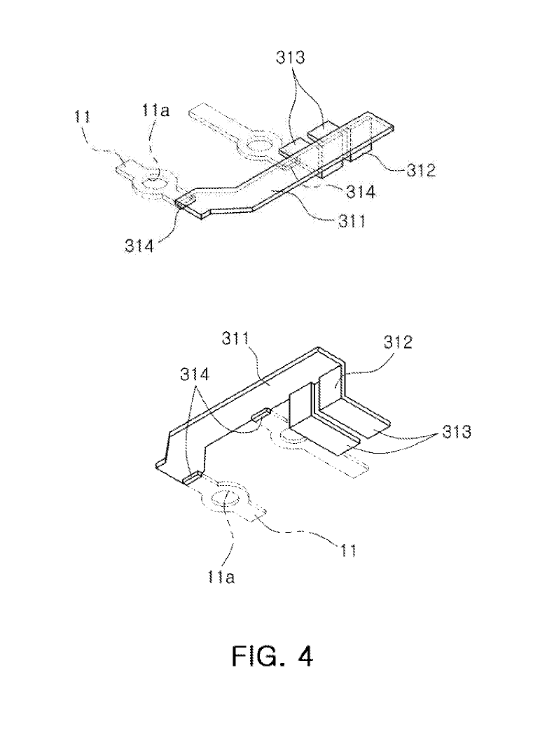

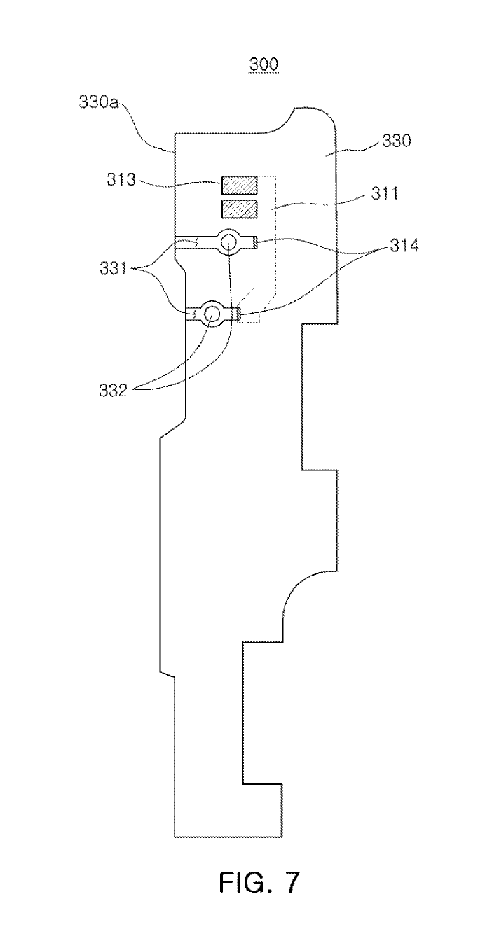

Referring to FIG. 7, a protrusion part 332 is provided in the opposite surface of the radiator frame 330 in which the bridge groove 331 is formed. The protrusion part 332 protrudes to the same level as a portion of the opposite surface of the radiator frame 330 in which the bridge groove 331 is not formed, and a plurality of protrusion parts 332 may be provided to be spaced apart from each other in the bridge groove 331. The protrusion part 332 as described above has a shape corresponding to a fixing hole 11a provided in the bridge 11 (See FIG. 4). That is, at the time of removing the bridge 11 after the radiator frame 330 is injection-molded, the resin provided in the fixing hole 11a of the bridge 11 forms the protrusion part 332.

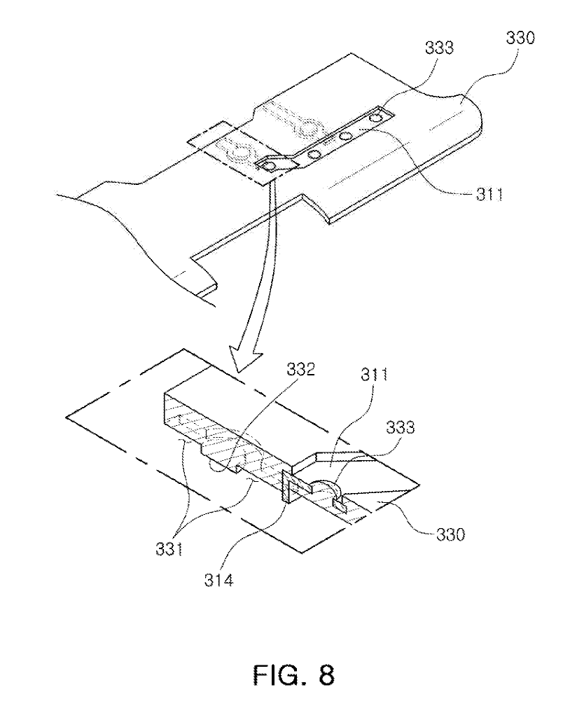

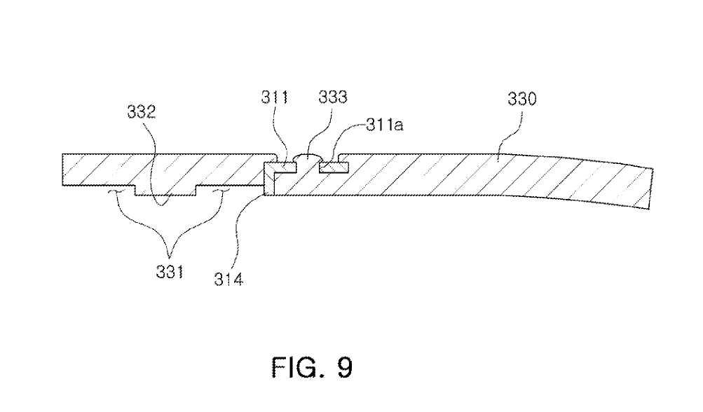

Referring to FIGS. 8 and 9, another example of an antenna pattern frame 300 includes a radiator 310 coupled to a radiator frame 330. The radiator 310 includes an antenna pattern part 311, a connecting part 312, a terminal connection part 313, and a support part 314. Here, the radiator 310 has a three-dimensional structure in which the antenna pattern part 311 and the terminal connection part 313 are bent, and the antenna pattern part 311 and the terminal connection part 313 are connected to each other by the connecting part 312. In other words, the connecting part 312 extends perpendicularly from the antenna pattern part 311 and the terminal connection part 313 extends perpendicularly from the connecting part 312. The connecting part 312 connects the antenna pattern part 311 and the terminal connection part 313 to each other so that the antenna pattern part 311 is formed on one surface of the radiator frame 330 and the terminal connection part 313 is formed on the opposite surface of the radiator frame 330.

Further, at least one guide pin hole 311a is provided in the antenna pattern part 311, and a resin is provided in and on the guide pin hole 311a forming an over molding part 333.

The support part 314 is bent from one side of the antenna pattern part 311, and an end portion thereof is exposed on an opposite surface of the radiator frame 330 after injection-molding. For example, the support part 314 is bent from one side of the antenna pattern part 311 to extend through the radiator frame 330, and the end portion is exposed on the opposite surface of the radiator frame 330.

The radiator frame 330, an injection-molded structure, forms the exterior of the antenna pattern frame 300, and a portion of the radiator 310 is embedded in the radiator frame 330. For example, the radiator frame 330 is molded by insert injection-molding of the radiator 310. The antenna pattern part 311 of the radiator 310 is exposed on one surface of the radiator frame 330, and the connection terminal 313 of the radiator 310 and the end portion of the support part 314 is exposed on the opposite surface of the radiator frame 330. In other words, the radiator 310 is inserted into a mold and radiator frame 330 is injection-molded around the radiator 310 so that the antenna pattern part 311 is exposed on one surface of the radiator frame 330 and the connection terminal 313 and the end portion support part 314 are exposed on the opposite surface of the radiator frame 330.

Referring to FIG. 9, an over-molding part 333 extends from the one surface of the radiator frame 330 through a guide pin hole 311a of the antenna pattern part 311, and an end portion of the over-molding part 333 covers a portion of an upper surface of the antenna pattern part 311 circumscribing the guide pin hole 311a. In this case, the antenna pattern part 311 is embedded in one surface of the radiator frame 330 at a predetermined depth, and an upper surface of the over-molding part 333 is disposed to be level with or lower than the one surface of the radiator frame 330.

The over-molding part 333 as described above covers a boundary line of the guide pin hole 311a. Therefore, a line formed by the guide pin hole 311a is hidden.

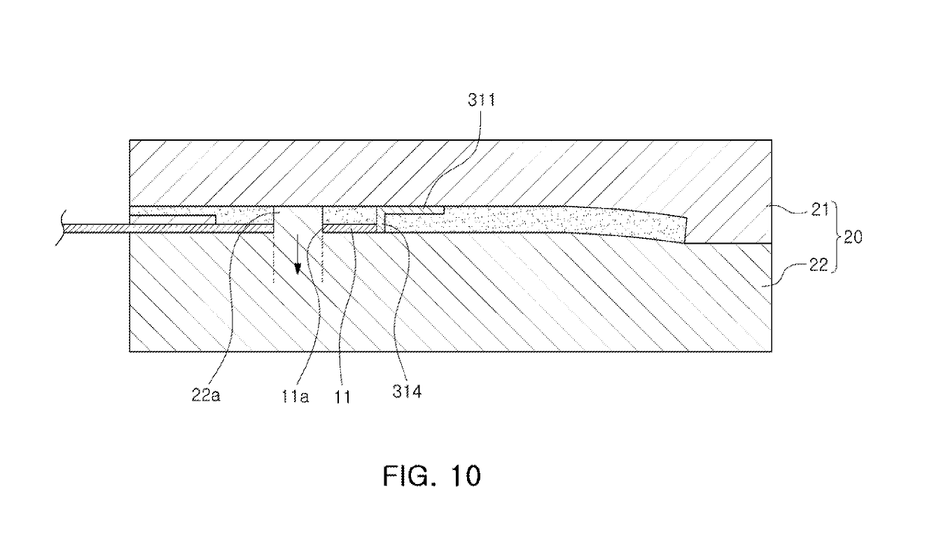

Hereinafter, the method of manufacturing an antenna pattern frame will be described with reference to FIGS. 10 through 12.

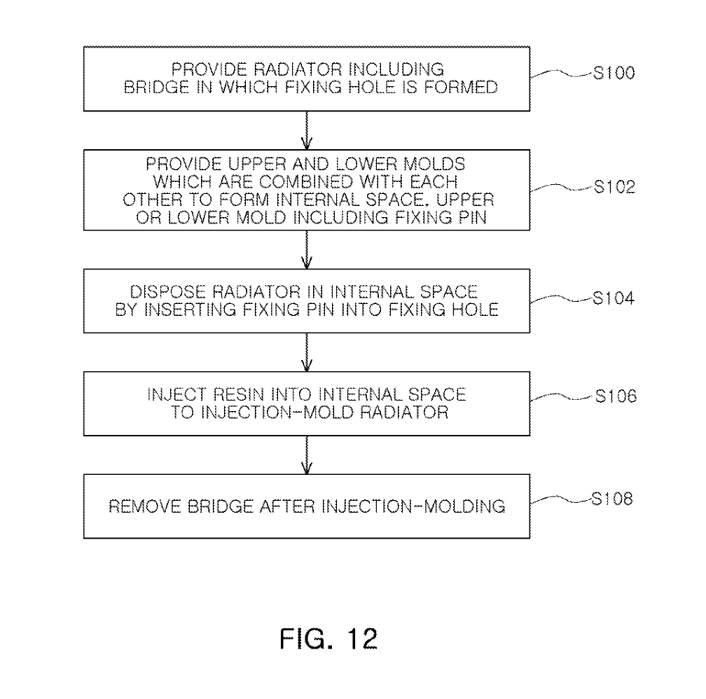

Referring to FIG. 12, the method of manufacturing an antenna pattern frame according to an exemplary embodiment includes: providing a radiator 310 including a bridge 11 in which a fixing hole 11a is formed (S100); providing upper and lower molds 21 and 22 which are combined with each other to form an internal space of a mold 20, the upper or lower mold including a fixing pin 22a (S102); disposing the radiator 310 in the internal space of the mold 20 by inserting the fixing pin 22a into the fixing hole 11a (S104); injecting a resin into the internal space to injection-mold the radiator 310 (S106); and removing the bridge 11 after the injection-molding is completed (S108).

Here, the radiator 310 includes an antenna pattern part 311 transmitting or receiving signals and a support part 314 bent from one side of the antenna pattern part 311 and connected to the bridge. In addition, in the disposing of the radiator 310 in the internal space of the mold 20 (S104), the antenna pattern part 311 is disposed to be closely adhered to, or contact, one surface of the upper or lower mold 21 or 22, and the bridge 11 is disposed to be closely adhered to, or contact, one surface of the upper or lower mold 21 or 22 that does not contact the antenna pattern part 311. Therefore, after the injection-molding is completed, the antenna pattern part 311 is exposed to one surface of a radiator frame 330, and an end portion of the support part 314 and the bridge 11 are exposed to the opposite surface of the radiator frame 330.

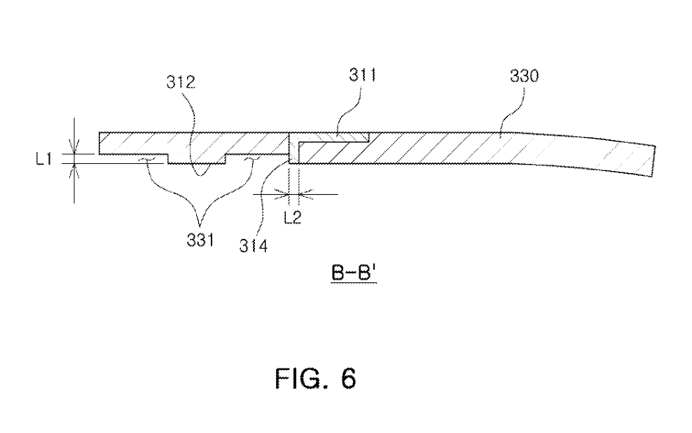

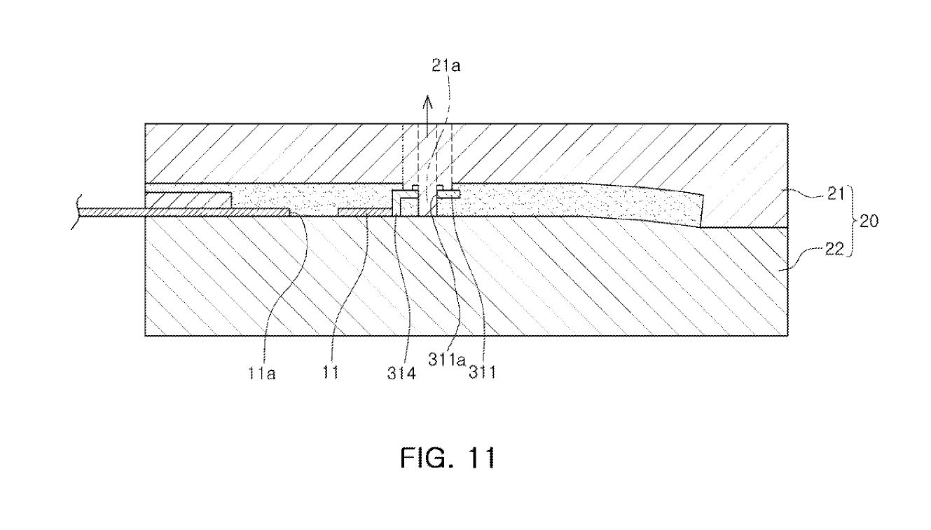

Further, in a case of disposing the radiator 310 in the internal space of the mold 20 (S104), the fixing pin 22a provided in the upper or lower mold 21 or 22 is inserted into the fixing hole 11a of the bridge 11, thereby preventing movement of the radiator 310 during injection-molding. Here, while injection-molding is performed, the fixing pin 22a is recessed by pressure of an injection solution in a direction of the arrow illustrated in FIG. 11, in order to form a protrusion part 332. After the injection-molding is completed, the removal of the bridge 11 is performed (S108), and thus a bridge groove 331 remains in the radiator frame 330 (see FIG. 6). Further, when the bridge 11 is removed, the protrusion part 332 remains as part of the radiator frame 330 and is formed by the resin provided in the fixing hole 11a of the bridge 11.

Referring to FIG. 11, a guide pin hole 311a may be provided in the antenna pattern part 311 of the radiator 310 according to the exemplary embodiment.

In a case in which the guide pin hole 311a is disposed in the antenna pattern part 311, a guide pin 21a corresponding thereto is disposed in the upper or lower mold 21 or 22, and the guide pin 21a is inserted into the guide pin hole 311a of the radiator 310 disposed in the mold. Thus, movement of the radiator 310 is limited by the guide pin 21a.

While the injection-molding is performed, the guide pin 21a is recessed, or ejected, from the mold cavity by pressure of an injection solution in the direction of the arrow illustrated in FIG. 11, and thus an over-molding part 330 is formed in the radiator frame 330.

As set forth above, in the antenna pattern frame and the electronic device including the same, the exterior thereof is improved.

As a non-exhaustive example only, a terminal or device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna pattern frame comprising:
a radiator comprising an antenna pattern part configured to transmit or receive a signal and a support part extending from one side of the antenna pattern part; and
a radiator frame wherein the antenna pattern part is exposed on one surface of the radiator frame and an end portion of the support part is exposed on an opposite surface of the radiator frame,
wherein a bridge groove is disposed in the opposite surface of the radiator frame extending from the exposed end portion of the support part to an edge of the radiator frame.

2. The antenna pattern frame of claim 1, wherein a protrusion part protrudes from the bridge groove.

3. The antenna pattern frame of claim 2, wherein the protrusion part has a height equal to a depth of the bridge groove.

4. The antenna pattern frame of claim 2, wherein the protrusion part comprises a plurality of protrusion parts spaced apart from each other in the bridge groove.

5. The antenna pattern frame of claim 1, wherein the support part comprises a plurality of support parts which are spaced apart from each other.

6. The antenna pattern frame of claim 5, wherein the bridge groove comprises a plurality of bridge grooves, and
the plurality of bridge grooves correspond to the plurality of support parts, respectively.

7. The antenna pattern frame of claim 1, wherein the bridge groove extends to a side surface of the radiator frame.

8. The antenna pattern frame of claim 1, wherein a depth of the bridge groove is equal to a thickness of the support part.

9. The antenna pattern frame of claim 1, wherein the antenna pattern part is provided with at least one guide pin hole.

10. The antenna pattern frame of claim 9, wherein the antenna pattern part is embedded in the one surface of the radiator frame.

11. The antenna pattern frame of claim 10, wherein one surface of the radiator frame is provided with an over-molding part which is disposed in the guide pin hole, and
a top portion of the over-molding part covers a portion of an upper surface of the antenna pattern part in which the guide pin hole is formed.

12. The antenna pattern frame of claim 11, wherein an upper surface of the over-molding part is disposed to be level with or lower than the one surface of the radiator frame.

13. The antenna pattern frame of claim 1, wherein the radiator comprises a different material from the radiator frame.

14. The antenna pattern frame of claim 1, wherein the antenna pattern part comprises a straight portion and an angled portion.

15. A method of manufacturing an antenna pattern frame, the method comprising:
combining an upper mold and a lower mold to form an internal space;
disposing a radiator and a bridge in the internal space, wherein the bridge comprises a fixing hole;
inserting a fixing pin through the upper and lower molds into the fixing hole;
injecting a resin into the internal space; and
removing the bridge after the injection-molding is completed.

16. The method of claim 15, wherein disposing the radiator in the internal space comprises:
bending a support part from one side of an antenna pattern part of the radiator and connecting the support part to the bridge.

17. The method of claim 16, wherein the antenna pattern part is disposed to be closely adhered to a surface of the upper or lower mold, and
the bridge is disposed to be closely adhered to a surface of the upper or lower mold that does not contact the antenna pattern part.

18. The method of claim 15, wherein disposing the radiator in the internal space comprises connecting a support part of the radiator to the bridge.
